(19) United States
(12) Patent Application Publication
(10) Pub. No.: US 2009/0003798 A1
(43) Pub. Date: Jan. 1, 2009

(54) CONTENT RECORDER/PLAYER

(76) Inventor: Hiroshi HAMASAKA, Osaka (JP)

Correspondence Address: MARK D. SARALINO (PAN);RENNER, OTTO, BOISSELLE & SKLAR, LLP, 1621 EUCLID AVENUE, 19TH FLOOR, CLEVELAND, OH, 44115, US

(21) Appl. No.: 12/146,603

(22) Filed: Jun. 26, 2008

(30) Foreign Application Priority Data
Jun. 29, 2007 (JP) 2007-172813

(51) Int. Cl. H04N 5/00; H04N 7/00

(52) U.S. Cl. 386/95; 386/126; 386/E05.001

(57) ABSTRACT

A device according to the present invention can record and play a content and can transmit and receive data to/from at least one secondary device. At least one parameter has been set for the secondary device to define configuration settings for the secondary device, which has the function of transmitting data about the at least one parameter upon request. The device includes: a network controller for transmitting and receiving data to/from the secondary device; a system controller, which requests the secondary device to transmit the data about the at least one parameter, which has been set in the secondary device, during an initialization process; and a storage medium for storing the data that has been transmitted from the secondary device and received at the network controller.

### BACKGROUND OF THE INVENTION

1. Field of the Invention

The present invention generally relates to a device that operates according to configuration setting parameters. More particularly, the present invention relates to a device that can record and/or play a content.

2. Description of the Related Art

Various types of recorders for recording a content such as a TV program on a DVD, a hard disk drive or any other storage medium have become increasingly popular these days. Meanwhile, players for playing back a content from a DVD have been used even more extensively than those recorders.

It is about ten years now since those devices were put on the market. And those devices have become so common nowadays that it is never rare to find a single household owning more than one such device. That is why it is expected that more and more users will purchase a brand-new device either in place of, or even in addition to, their old one(s).

In installing a brand-new device, however, it is necessary to enter various sorts of information about its configuration settings (which will be referred to herein as “configuration setting information”) into that device. Examples of such configuration setting information include information about reception channels selected, information about various user customized parameters including video recording quality (recording bit rate), audio quality, recording formats, whether the recorded titles should be presented as a list or as thumbnails, and whether a screen saver needs to be used or not, and user preference parameters (such as viewing control levels and passwords).

Japanese Patent Application Laid-Open Publication No. 2004-152450 discloses a method for defining configuration setting information for a recorder/player. Specifically, the recorder/player disclosed in the above document stores not only a program to be recorded but also configuration setting information on a removable storage medium. And when the recorded program needs to be played back from that storage medium using another recorder/player, that another recorder/player reads the configuration setting information and enters that information into itself. Then, there is no need for the user to define configuration settings all over again for every recorder/player newly purchased. And he or she can play back the recorded program using the new recorder/player with its configuration settings optimized to play back that recorded program.

However, the technique disclosed in the above document can be used just to get the same piece of configuration setting information shared by multiple recorders/players, but cannot be effectively applicable to a recorder/player that has been purchased as either a replacement or an additional device.

For example, if a recorder/player has been purchased as a replacement, the user should not only define configuration setting information for the brand-new recorder/player but also wish to transfer the TV program data stored in his or her old recorder/player to the new one. According to the technique disclosed in the above document, however, it is not possible to cope with such a situation where the data of every TV program that has ever been recorded should be transferred to a new recorder/player collectively.

In transferring the old TV program data, however, care should be further taken of the following respects.

Specifically, a normal removable information storage medium (such as a DVD) has storage capacity that is approximately two-digit lower than that of a non-removable information storage medium (such as a hard disk). For that reason, it is not a practical measure to take to transfer a huge size of old TV program data from the hard disk of an old recorder/player to that of a new one via a DVD.

Technically, it is naturally possible to disassemble the old and new recorders/players and exchange their hard disk drives with each other. That is to say, if the hard disk drive of the new recorder/player is replaced with that of the old one, the old TV program data can be entirely transferred to the new recorder/player as they are. However, generally speaking, the hard disk of a recorder/player newly purchased often has bigger storage capacity than that of an old one. Considering this point, it is not so beneficial for the user who has just purchased a brand-new recorder/player to exchange the hard disk drives themselves.

On top of that, if a recording schedule has already been set in the old recorder/player, then the recording schedule should also be transferred to the new recorder/player. Nevertheless, the above document is silent about how to transfer such recording schedule information.

Furthermore, if the user plans to give away his or her old recorder/player to somebody else, then the configuration setting information defined in that device and the recorded TV program data stored there should be called his or her personal information and should not be left in that recorder/player. However, the above document does not mention how to handle that type of information, either.

The same can be said even if the user has purchased an additional recorder/player, not as a replacement. In many cases, he or she will use the brand-new recorder/player most of the time and will use the old one only occasionally. Then, the content and parameter data should also be transferred from the old recorder/player to the new one.

### SUMMARY OF THE INVENTION

In order to overcome the problems described above, the present invention has an object of providing a scheme for transferring the content data stored in an old recorder/player and data about the parameters that have been set to define configuration settings for that device to another recorder/player that has been newly purchased as either a replacement or an additional device.

A device according to the present invention can record and play a content and can transmit and receive data to/from at least one secondary device. At least one parameter has been set for the secondary device to define configuration settings for the secondary device, which has the function of transmitting data about the at least one parameter upon request. The device includes: a network controller for transmitting and receiving data to/from the secondary device; a system controller, which requests the secondary device to transmit the data about the at least one parameter, which has been set in the secondary device, during an initialization process; and a storage medium for storing the data that has been transmitted from the secondary device and received at the network controller.

In one preferred embodiment of the present invention, the system controller further requests the secondary device to transmit at least a part of content data that is stored in the secondary device.

In another preferred embodiment, on being notified that the data has been received successfully, the system controller instructs the secondary device to erase that data.

In still another preferred embodiment, the storage medium includes a first storage medium on which the data about the at least one parameter is written and a second storage medium on which every data about the content is written.

In yet another preferred embodiment, the network controller can transmit and receive data to/from not only the at least one secondary device as a first terminal device but also another secondary device as a second terminal device over a network independently of each other. In response to a request received from the second terminal device, the system controller issues an instruction that the data that has been received from the first terminal device and then stored on the storage medium be transmitted to the second terminal device. In accordance with the instruction given by the system controller, the network controller transmits the data to the second terminal device.

In this particular preferred embodiment, the network controller can communicate with the second terminal device, no matter whether the first terminal device is connected to the network or not.

In yet another preferred embodiment, the at least one secondary device includes multiple secondary devices. The network controller can transmit and receive data to/from each of those secondary devices. The system controller requests at least one secondary device, which has been selected from those secondary devices, to transmit the data. The storage medium stores the data that has been transmitted from the at least one secondary device selected and then received at the network controller.

Another device according to the present invention can record and/or play a content, and includes: a network controller for transmitting and receiving data to/from a secondary device, in which a number of parameters have been set to define its configuration settings; a system controller, which requests the secondary device to transmit the data about the number of parameters, which have been set in the secondary device, during an initialization process; a storage medium for storing the data that has been transmitted from the secondary device and received at the network controller; and a graphics controller for generating a signal to display information on a display device. Based on the signal that has been generated by the graphics controller, at least one exercisable option is displayed on the display device. The system controller requests the secondary device to transmit data that has been defined in advance for the at least one option exercised.

In one preferred embodiment, the graphics controller displays multiple exercisable options, each of which is associated with the number of parameters. The system controller requests the secondary device to transmit the data about the parameters that are associated with the at least one option exercised.

In this particular preferred embodiment, the system controller further requests the secondary device to transmit at least a part of content data that is stored in the secondary device.

In a specific preferred embodiment, the parameters associated with the at least one option include recording schedule information.

In another preferred embodiment, the content data has been compressed by a first encoding method. The device further includes an encoder that changes the encoding methods from the first one into a second one, which is different from the first one, on receiving the at least part of the content data and then stores the encoded data on the storage medium.

In still another preferred embodiment, the system controller determines whether or not the secondary device is ready to transmit the data about the parameters.

In this particular preferred embodiment, the system controller requests the secondary device to transmit device information that identifies the secondary device itself. Based on the device information that has been transmitted from the secondary device and then received at the network controller, the system controller determines whether or not the secondary device is ready to transmit the data about the parameters.

In still another preferred embodiment, the graphics controller displays, as the multiple options, pieces of information about parameters that have been set in the secondary device to record the content, play the content and carry out a recording schedule, respectively.

In yet another preferred embodiment, the device further includes a command receiver for receiving a user's command. The command receiver is instructed which of the multiple options the user is going to exercise. The system controller requests the secondary device to transmit data required by the user's command.

In yet another preferred embodiment, the graphics controller further displays, as another option, pieces of information indicating whether or not the data that has been transmitted from the secondary device needs to be erased from the secondary device.

In this particular preferred embodiment, the device further includes a command receiver for receiving a user's command. When the command receiver receives a data erase command from the user, the system controller instructs the secondary device to erase the data as soon as the data has been received.

In yet another preferred embodiment, the device further includes a command receiver for receiving a user's command. The command receiver is instructed which of the multiple options the user is going to exercise. Each of the options displayed on the display device has been associated with multiple parameters in advance. When any of the options is exercised, the system controller requests the secondary device to transmit data about the multiple parameters that have been associated in advance with that option.

A device according to the present invention requests a secondary device to transmit data about at least one parameter, which has been set to define its configuration settings, in accordance with the user's command. The data thus received gets stored in the storage medium of the device of the present invention. The device of the present invention operates on that data stored in the storage medium, and therefore, can define the same configuration settings as the secondary device's. Besides, if at least part of the content data stored in that secondary device is transmitted from the secondary device, then the user can easily change the devices to use from the old one into the new one.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 illustrates how a group of devices, including an optical disc recorder 20 with a built-in HDD (new recorder 20) as a first preferred embodiment of the present invention, may be connected together.

FIG. 2 illustrates a hardware configuration for the optical disc recorder 20 with a built-in HDD according to the first preferred embodiment.

FIGS. 3A through 3D illustrate typical dialog boxes that are displayed on the TV screen 41 to perform the setting transfer function.

FIG. 4 is a flowchart showing the procedure of the setting transfer process to be done by the new recorder 20 of the first preferred embodiment.

FIG. 5 illustrates another dialog box that is displayed on the TV screen 41 with an option 51 that the user leaves it to the new recorder 20 to determine exactly what to inherit.

FIG. 6 illustrates a LAN 10 to which a PC 60 is connected.

FIG. 7 illustrates a LAN 10 to which two old recorders 30 and 50 and a new recorder 20 are connected.

FIGS. 8A through 8D illustrate typical dialog boxes that are displayed on the TV screen 41 when the new recorder 20 performs the setting transfer function on multiple old recorders.

FIG. 9 is a flowchart showing a procedure in which the new recorder 20 performs the setting transfer function.

### DETAILED DESCRIPTION OF PREFERRED EMBODIMENTS

### Embodiment 1

Hereinafter, preferred embodiments of a device according to the present invention will be described with reference to the accompanying drawings. In the following description of preferred embodiments, the device of the present invention is supposed to be an optical disc recorder with a built-in hard disk drive (HDD), which can record and play back a TV program on/from an optical disc or a hard disk.

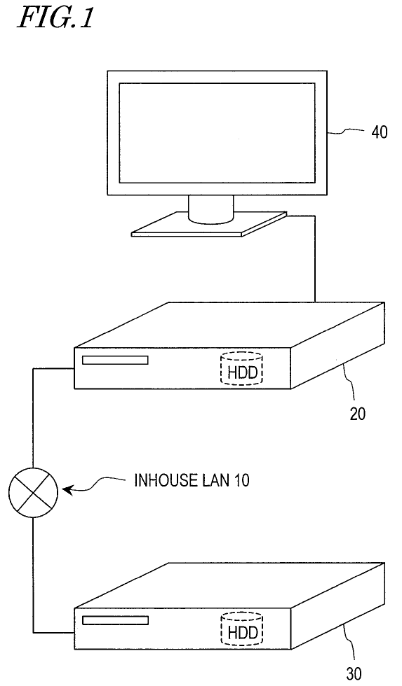

FIG. 1 illustrates how a group of devices, including an optical disc recorder 20 with a built-in HDD as a first preferred embodiment of the present invention, may be connected together. In this example, the optical disc recorder 20 with the built-in HDD has been newly purchased, connected to a TV 40 and to an inhouse LAN 10, and is ready to communicate with an old optical disc recorder 30 with a built-in HDD that has been used so far.

In the following description of preferred embodiments, the optical disc recorder 20 with the built-in HDD will be simply referred to herein as either a “brand-new recorder” or just a “new recorder”. Meanwhile, the optical disc recorder 30 with the built-in HDD will be referred to herein as either an “old recorder” or a “existent recorder”. It should be noted that the terms “old” and “new” refer to the order of use. That is why the “new” recorder is just relatively new compared to the “old” recorder but does not have to be one of the newest models that have just gone on public sale.

The connection shown in FIG. 1 is an indispensable configuration that is required for the new recorder 20 to perform the setting transfer function (to be described later) with the old recorder 30. Once that function has been performed, however, the new recorder 20 no longer has to be connected to the old one 30 through the LAN 10. Also, once that function has been carried out, the old recorder 30 may be moved to a different room from the new recorder's 20 so as to be used by the user himself or herself or by his or her family member as an additional device, given to somebody else, or even no longer used. In the following example, the old recorder 30 is supposed to be given to somebody else.

Next, the hardware configuration of the new and old recorders 20 and 30 will be described. As far as the hardware configuration is concerned, the new and old recorders 20 and 30 are basically identical with each other. That is why only the configuration of the new recorder 20 will be described. The only differences between the old and new recorders 30 and 20 lie in whether or not recorded programs are stored on the hard disk and whether or not parameters defining the configuration settings for the old recorder 30 have been set by the user.

The old recorder 30 has the function of transmitting data on receiving a request from another device (such as the new recorder 20) that is connected to the network such as the inhouse LAN 10. This “data” may be either data about at least one parameter that has been set to define the configuration settings or part or all of the data about a recorded and stored TV program as will be described later. Or the data may even be a piece of information required to carry out a recording schedule.

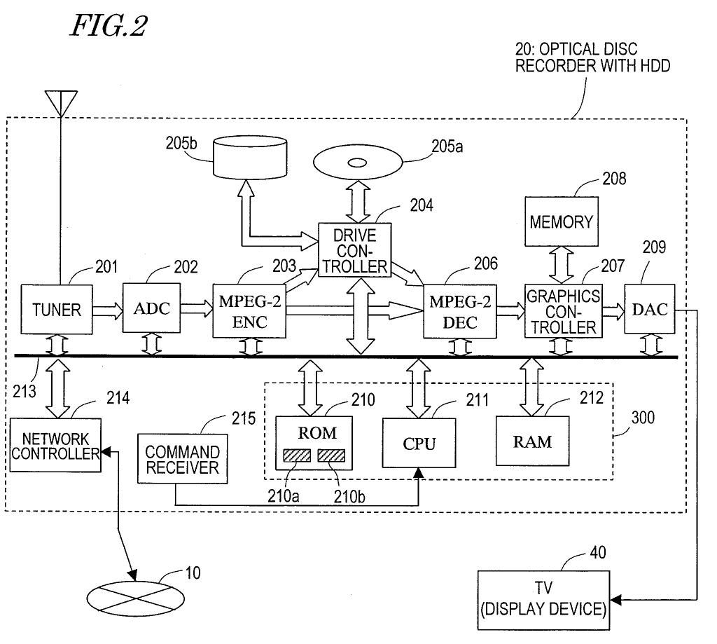

FIG. 2 illustrates a hardware configuration for the new recorder 20 according to this preferred embodiment.

The primary functions of the new recorder 20 include the function of recording a content (which is typically a TV program) and the function of playing back the recorded program. These functions will be referred to herein as a “recording function” and a “playback function”, respectively.

Another important function of the new recorder's 20 is the setting transfer function, which is one of the principal features of the present invention. The setting transfer function includes a configuration setting transfer function and a recorded program transfer function.

As used herein, the “configuration setting transfer function” is a function performed by the new recorder 20 by getting data about at least one parameter, which has been set to define the configuration settings for the old recorder 30, from the old recorder 30 and setting it as its own configuration setting parameter.

On the other hand, the “recorded program transfer function” is another function performed by the new recorder 20 by getting part or all of the data about the TV programs that have ever been recorded and stored in the old recorder 30 from the old recorder 30 and storing the data about those programs on its own built-in hard disk. The configuration setting transfer function and the recorded program transfer function may be both performed or one of these two functions may be performed selectively, which is determined arbitrarily by the user according to his or her preference.

In the old recorder 30, the parameters have been set uniquely and the programs have been recorded on respective storage media (such as the hard disk). For that reason, unless transferred from the old recorder 30 to the new recorder 20, the parameters cannot be set in the new recorder 20 or the recorded programs cannot be saved in the new recorder 20, either.

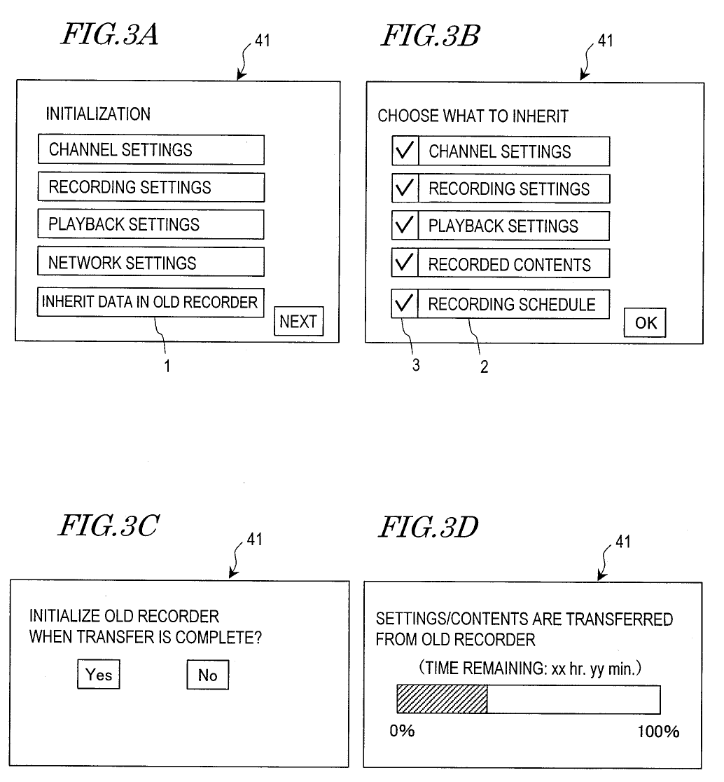

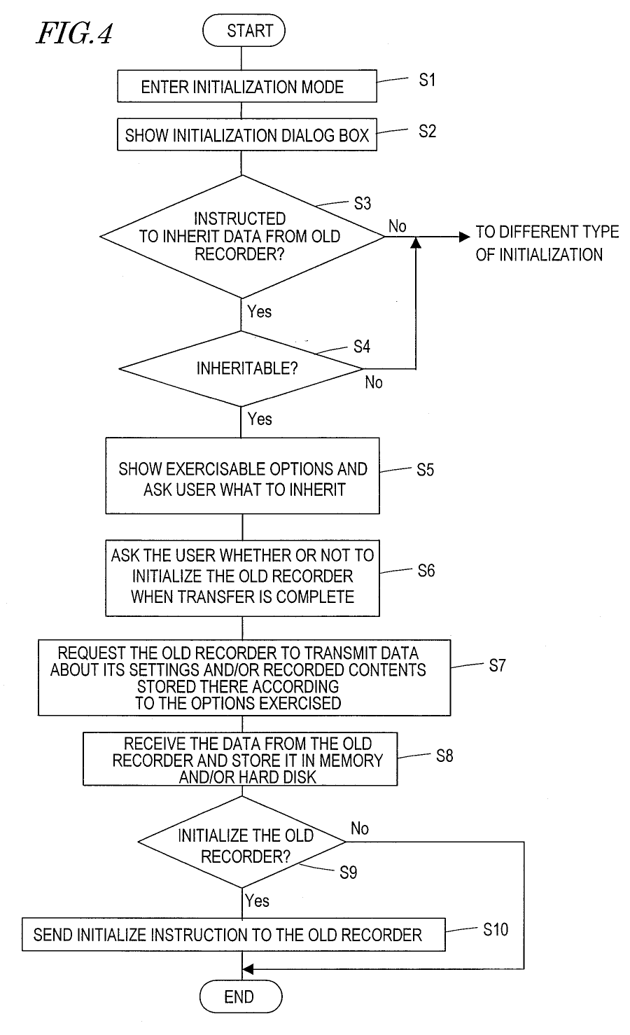

Hereinafter, the hardware configuration of the new recorder 20 will be described mainly in terms of its recording function and playback function. After that, the configuration of some hardware components of the new recorder 20 that perform the setting transfer function and the processing done by those components will be described with reference to FIGS. 3 and 4.

The new recorder 20 includes a tuner 201, an A/D converter 202, an MPEG-2 encoder 203, a drive controller 204, an MPEG-2 decoder 206, a graphics controller 207, a memory 208, a D/A converter 209, a CPU bus 213, a network controller 214, a command receiver 215 and a system controller 300.

In performing a recording operation, the new recorder 20 receives a signal representing a content (such as a TV program) from a broadcaster, generates a data stream based on that signal, and then writes the data stream on either an optical disc 205a or a hard disk 205b. The TV program signal received may be either a signal representing an analog telecast or a signal representing a digital telecast. In the example illustrated in FIG. 2, a configuration for digitizing the signal representing an analog telecast, encoding the signal and then storing it on either the optical disc 205a or the hard disk 205b is shown.

On the other hand, in performing a playback operation, the new recorder 20 reads the data about the recorded TV program from either the optical disc 205a or the hard disk 205b, decodes the data, and then outputs the decoded data to the TV 40.

It is determined by the user himself or herself whether the TV program received should be recorded on the optical disc 205a or the hard disk 205b. Likewise, it is also the user himself or herself who decides whether the TV program to play should be read from the optical disc 205a or from the hard disk 205b.

The optical disc 205a may be a CD, a DVD or a BD, for example. In the following example, the optical disc 205a is supposed to be a DVD. It should be noted that although the optical disc 205a is illustrated inside the block of the new recorder 20, the optical disc 205a is actually removable from the new recorder 20 and does not form an integral part of the new recorder 20.

The system controller 300 controls the overall processing to be done by this new recorder 20, and includes a ROM 210, a CPU 211 and a RAM 212, which are all connected to the CPU bus 213.

The ROM 210 may be an electrically erasable programmable ROM (EEPROM), for example. A computer program 210a for operating the new recorder 20 is stored in the ROM 210.

Also stored in the ROM 210 are parameters 210b that define configuration settings for the new recorder 20. In the new recorder 20 just purchased, those parameters are default parameters that were set when the device was shipped from the manufacturer. However, if the user has changed the settings afterwards or if any program has been installed externally, those parameters are updated into different ones.

The ROM 210 is usually a non-removable nonvolatile memory, and therefore, retains the data even when the recorder is once turned OFF and then turned ON again. That is to say, the same data can be read again from the ROM 210 even after the recorder has been once turned OFF. Since the ROM 210 is built in the recorder, the parameters can always be read, no matter how this recorder is used, unlike the situation where the parameters are stored on a removable storage medium.

In accordance with the user's command, the CPU 211 outputs either a write instruction or a read instruction. More specifically, by executing the computer program 210a, the CPU 211 generates instructions (as control signals) to get the processing done as defined by the computer program 210a in accordance with the user's command and outputs those control signals to the respective components through the CPU bus 213. In accordance with those instructions, the components perform their own functions to get the recording and playback processing done.

The RAM 212 has a work area that should be provided for the CPU 211 to execute the program. For example, the CPU 211 may read the computer program 210a from the ROM 210 and get the program 210a transferred through the CPU bus 213 and then expanded on the work area of the RAM 212.

The tuner 201 tunes itself to, and receives, analog broadcasting wave that has been transmitted from the broadcaster and outputs the video and audio signals of the received program to the A/D converter 202, which converts the input signals into digital ones and supplies them to the MPEG-2 encoder 203. On receiving an instruction to start a recording operation, the MPEG-2 encoder 203 (which will be simply referred to herein as an “encoder 203”) encodes the supplied digital data into the MPEG-2 format, generates an MPEG-2 program stream (which will be simply referred to herein as a “program stream”) compliant with the DVD Video Recording standard and then passes it to the drive controller 204. This processing is continued until the encoder 203 is given an instruction to end the recording operation. The encoder 203 includes a buffer (not shown) for temporarily storing frame data and other data in order to get the encoding done.

The drive controller 204 controls reading and writing of data from/on the optical disc 205a using an optical head (not shown). In addition, the drive controller 204 also controls reading and writing of data from/on the hard disk 205b using an magnetic head (not shown, either).

More specifically, on receiving an instruction to start a recording operation, the drive controller 204 performs recording start processing. After that, on receiving the program stream, the drive controller 204 starts writing it on either the optical disc 205a or the hard disk 205b. Also, when the program stream is no longer input after the instruction to end the recording operation has been received, the drive controller 204 ends the write processing and performs recording end processing. In this example, the drive controller 204 is supposed to control the exchange of information with both the optical disc 205a and the hard disk 205b. Optionally, the drive controller 204 may be provided for each of a drive for the optical disc 205a and a drive for the hard disk 205b.

On the other hand, in playing back a recorded program, the drive controller 204 sets either the optical disc 205a or the hard disk 205b in a read enabled state and reads data from it. Then, the drive controller 204 outputs the read data to the MPEG-2 decoder 206. The MPEG-2 decoder 206 (which will be simply referred to herein as a “decoder 206”) expands the MPEG-2 encoded data supplied, converts it into decompressed data and then passes it to the graphics controller 207. The graphics controller 207 is connected to the internal computer memory 208 and realizes an on-screen display (OSD) function. For example, the graphics controller 207 combines any of various menu pictures with the video and outputs the resultant synthetic image to the D/A converter 209. In response, the D/A converter 209 converts the input OSD synthetic image and audio data into analog data and outputs them.

The CPU bus 213 is a path for transferring signals in the new recorder 20. The tuner 201, A/D converter 202, encoder 203, drive controller 204, decoder 206, graphics controller 207, D/A converter 209 and system controller 300 are all connected to the CPU bus 213.

The network controller 214 has an interfacing function for connecting the new recorder 20 to the inhouse LAN 10 (which will be simply referred to herein as a “LAN 10”) and exchanges data over the LAN 10. This data may be data about parameters that have been set in the old recorder 30 to perform the setting transfer function to be described later and/or data about a recorded program that is stored in the old recorder 30.

In this preferred embodiment, the network controller 214 is supposed to be a connection terminal compliant with the Ethernet™ standard. However, this is just an example. Alternatively, as long as data can be exchanged between the new and old recorders 20 and 30, the network controller 214 may also be any other type of interface (such as an IEEE 1394 interface).

The command receiver 215 is a switch that allows the user to select a channel on, or get a recording or playback operation done by, the new recorder 20. The command receiver 215 may further include an input device such as a keyboard that allows the user to enter his or her search keyword or a mouse that allows the user to select his or her desired search keyword. Still alternatively, the command receiver 215 may also be an infrared receiver to receive an infrared ray that has been transmitted from a remote controller (not shown).

The network controller 214 is connected to the CPU 211 (to be described later) of the system controller 300 by way of the CPU bus 213. On the other hand, the command receiver 215 is directly connected to the CPU 211. A signal generated by operating the command receiver 215 is supplied to the CPU 211.

The command receiver 215 is connected to the CPU 211 and receives user's commands about channel selection, recording, playback, clock adjustment, recording schedule setting and so on directly from him or her.

Hereinafter, it will be described how the new recorder 20 operates to perform its setting transfer function.

FIGS. 3A through 3D illustrate typical dialog boxes that are displayed on the TV screen 41 to perform the setting transfer function. The graphic data displayed in these boxes are generated by the graphics controller 207 in accordance with the instruction given by the CPU 211 of the system controller 300.

FIG. 3A illustrates an initialization dialog box. This dialog box appears during the initialization (e.g., when the new recorder 20 is turned ON for the first time or when the user has entered a command to show this initialization dialog box). In this dialog box, multiple exercisable options such as channel settings and recording settings are displayed.

This exemplary dialog box is characterized by including an option 1 that says “inherit the data in the old recorder”. If this option 1 is picked up, the new recorder 20 understands that it has been instructed to transfer the settings from the old recorder 30 and starts performing the setting transfer function, which is at least one of the configuration setting transfer function and the recorded TV program transfer function.

FIG. 3B illustrates an exemplary dialog box that appears while the setting transfer function is being performed. The graphics controller 207 displays pieces of information about at least one parameter that has been set in the old recorder 30 and pieces of information about the recorded program stored in the old recorder 30 as multiple options on the screen 41.

In the example illustrated in FIG. 3B, “channel settings”, “recording settings”, “playback settings”, “recording schedule” and other options are displayed as pieces of information about the parameters that have been set in the old recorder 30. Also, another option called “recorded contents” is also displayed as a piece of information about the recorded TV programs.

The respective options shown in FIG. 3B have the following meanings.

For “channel settings”, parameters about channel tuning, number displays, line input displays and so on are defined. These parameters are required in order to view and listen to a TV program and record it.

As for “recording settings”, various parameters to be applied when the user presses a recording button (not shown) are defined. Examples of those parameters include parameters about a recording bit rate, a recording format, and an audio format. Those parameters have been defined by the user according to his or her preference.

On the other hand, as for “playback settings”, various parameters about whether or not viewing of any content is controlled, whether a password has been set to remove the viewing control, whether or not there is a parental lock when a DVD is played, what language is selected as audio and subtitle language, and what are color temperature, luminance and contrast ratio preferred, are defined.

Furthermore, as for “recording schedule”, various parameters required to carry out the recording schedule, including the recording channel number, recording date (which may be a particular day, everyday, or the same day of the week), recording start and end times, recording bit rate, recording format and audio format, are defined. The recording schedule information can also be transferred from the old recorder 30 to the new recorder 20. Thus, there is no need for the user to enter the same recording schedule into the new recorder 20 all over again.

The “recorded contents” are either some or all of the recorded TV programs that are stored in the old recorder 30.

In FIG. 3B, checkboxes 3 are displayed along with the respective options 2. If any of these checkboxes 3 is checked, then every piece of information about the parameters that have been defined for that matter will be transferred from the old recorder 30 to the new recorder 20. On the other hand, if none of these checkboxes 3 are checked, then no information about the parameters defined for that matter will be transferred from the old recorder 30 to the new one 20.

In the example illustrated in FIG. 3B, all of those checkboxes 3 are checked, and therefore, every data about all parameters that have been set in the old recorder 30 and every data about all TV programs that are stored in the old recorder 30 are transferred to the new recorder 20. The data about all TV programs saved may have been generated in an encoding format compliant with an MPEG standard, for example. In such a encoded state, even such a huge amount of data can be transferred from the old recorder 30 to the new one 20 by way of the LAN 10.

It should be noted that the options shown in FIG. 3B and the types of parameters associated with those options are just an example. Thus, any other option may be provided additionally. For example, another option called “device settings” may be provided to define various parameters about the luminance of a display tube (not shown) on which either a counter or a clock is displayed, the aspect ratio of an output image, whether or not an HDMI output is needed, how long the device could wait for the user's next input before entering a standby mode, and which of the two modes of dubbing operation (including a noise reduced mode and a quick mode) the user prefers.

FIG. 3C illustrates a dialog box that asks the user if he or she wants to initialize the old recorder 30. If he or she wants to initialize the old recorder 30, he or she chooses YES. Otherwise, he or she chooses NO.

In this case, “to initialize the old recorder 30” means erasing part of all of the settings from the old recorder 30. In this preferred embodiment, it means erasing at least the data that has been inherited from the old recorder 30 to the new one 20 (i.e., data about the configuration setting parameters transferred and the recorded programs transferred). Once the configuration setting parameters have been erased, the settings determined by the user are cleared and the original parameters of the old recorder 30 that were set when it was shipped from the factory are selected by default.

The new recorder 20 prompts the user to determine whether or not he or she wants to initialize the old recorder 30 because circumstances will differ depending on whether or not he or she is going to use the old recorder 30 continuously. Specifically, in a situation where he or she plans to give away the old recorder 30 to somebody else or just throw it away, if his or her settings or recorded programs, which belong to his or her sensitive personal information, remained in the old recorder 30 as they are, then a third party might acquire or abuse that personal information illegally. That is why that sort of information should be erased by initialization. Also, if the old recorder 30 requires the user to enter credit card information when he or she wants to purchase a content for viewing, then such credit card information, if anything left, must be erased. Meanwhile, if the user plans to use the old recorder 30 continuously, he or she may want no initialization.

It is not impossible for the user to connect the old recorder 30 to the TV 40 again, start the old recorder 30, and then erase those pieces of information one by one manually without resorting to the initialization processing. However, this is a very troublesome and time-consuming job for him or her. But the new recorder 20 of this preferred embodiment can erase such personal information automatically without causing the user such trouble as the configuration setting parameters are transferred. Thus, this recorder 20 comes in very handy for him or her.

FIG. 3D illustrates an exemplary dialog box that appears while data about the configuration setting parameters and the recorded contents that have been stored in the old recorder 30 are being transferred to the new recorder 20.

When everything necessary to start performing the setting transfer function has been entered, the system controller 300 of the new recorder 20 will request the old recorder 30 to transmit data about the configuration setting parameters and the recorded contents. In response to the request, the old recorder 30 will transfer the requested data to the new recorder 20.

As shown in FIG. 3D, a progress bar, indicating how far the process has advanced, and estimated process time, indicating how long it would take to get the process done, are displayed on the screen 41. In this case, data about a lot of configuration setting parameters should be transferred from the old recorder 30 to the new one 20 and the data size of the recorded programs is too big to transfer it in a short time. For that reason, the display of the estimated process time and the progress bar is an effective means for allowing the user to confirm the processing status.

According to this preferred embodiment, if the user wants, the configuration setting parameters and the recorded contents can all be transferred at a time from the old recorder 30 to the new recorder 20. Only if the user makes the selections shown in FIGS. 3A to 3C just once, everything will be transferred automatically after that, thus significantly lightening his or her workload. It is not impossible to transfer the configuration setting parameters and the recorded contents on a one-by-one basis. According to such a method, however, the instant some data has been transferred, the user would have to perform the operation of transferring the next data immediately. In that case, he or she should be at the recorder all the time until every data has been transferred successfully. That is to say, he or she would have to wait a much longer time and have to get far more jobs done. That is why it is very effective to allow the user to choose only the type of data he or she wishes to transfer and then get every data transferred at a time as is done in this preferred embodiment.

Next, it will be described exactly how the new recorder 20 performs the setting transfer function.

FIG. 4 shows the procedure of the setting transfer process to be done by the new recorder 20.

First, in Step S1, the system controller 300 senses that the recorder 20 has been turned ON for the first time or the user chooses to display an initialization dialog box, thus making the recorder 20 enter an initialization mode. Next, in Step S2, the CPU 211 instructs the graphics controller 207 to open the window shown in FIG. 3A.

Next, in Step S3, the CPU 211 determines whether or not a user's command to inherit the data stored in the old recorder 30 has been received. This processing step is equivalent to determining whether or not the user has exercised the option 1 shown in FIG. 3A. That is to say, if the user has picked up the option 1, the process advances to Step S4. On the other hand, if he or she has exercised any other option, then the process changes its types into another initialization processing (such as reception channel setting process). In that case, the process shown in FIG. 4 ends.

Next, in Step S4, the CPU 211 determines whether the data stored in the old recorder 30 is inheritable or not. More specifically, when the initialization mode is entered, the CPU 211 requests the old recorder 30 to transmit the device information (such as the name of its manufacturer and the product code number) by way of the network controller 214 and the LAN 10. On acquiring the device information that has been transmitted by the old recorder 30 in response to that request, the CPU 211 searches a compatible device list, which may be stored in advance in the ROM 210, for example, with that device information.

If that device is on the compatible device list, the CPU 211 determines that the data stored in the old recorder 30, including configuration setting parameters and content data, is inheritable. Then the process advances to Step S5.

On the other hand, if the device is not on the compatible device list or if there is no response to the request to transmit the device information, then the CPU 211 determines that the data stored in the old recorder 30 is non-inheritable. Then, the process changes its modes into a different type of initialization processing.

At the beginning of description of this preferred embodiment, the old recorder 30 is supposed to have the function of transmitting data upon request. However, in general, not every device connected to the LAN 10 has such a function. That is why this preferred embodiment provides the processing step S4 to allow the new recorder 20 to cope with the general usage.

Next, in Step S5, the graphics controller 207 displays the options 2 to exercise and the checkboxes 3 as shown in FIG. 3B. When the user determines what processing to do by checking or not checking the checkboxes 3, the command receiver 215 knows his or her intention in what data to inherit. Optionally, the inheritable data from the old recorder 30 may be described on the compatible device list mentioned above.

Next, in Step S6, when the graphics controller 207 displays the dialog box shown in FIG. 3C, the command receiver 215 receives the user's command to or not to initialize the old recorder 30.

Subsequently, in Step S7, as for the options to inherit that have been exercised, the CPU 211 requests the old recorder 30 to transmit data about the settings defined in the old recorder 30 and/or data about the recorded contents stored in the old recorder 30.

After the old recorder 30 has transmitted the specified data upon that request, the new recorder 20 receives that data in Step S8 by way of the network controller 214.

If the received data includes data about configuration setting parameters, the CPU 211 stores that data as parameters 210b on the ROM 210. The new recorder 20 operates with its channels and recording rate (or recording quality) defined according to the parameters 210b. That is why once the parameters 210b have been set based on the received data, the new recorder 20 is ready to operate under the same configuration as the old recorder 30.

On the other hand, if the received data includes data about the recorded TV programs, the CPU 211 stores that data on the hard disk 205b. This is because a TV program usually has too big a data size to store on the ROM 210 or the RAM 212.

In this preferred embodiment, the parameter data that defines configuration settings for the old recorder 30 is supposed to be stored on the ROM and the data about the recorded TV programs is supposed to be stored on the hard disk of the old recorder 30. And when those data are transferred to the new recorder 20, the parameter data that defines configuration settings will be stored on the ROM of the new recorder 20 and the data about the recorded TV programs will be stored on the hard disk of the new recorder 20.

The hard disk 205b and the ROM 210b are non-removable from the new recorder 20. Optionally, the TV program data may be stored on a removable optical disc 205a instead of the hard disk 205b of the new recorder 20. Generally speaking, however, as the hard disk 205b has bigger storage capacity than the optical disc 205a, the restriction on data size will be less strict during the transfer process if the data is supposed to be stored on the hard disk 205b.

In this example, the transferred data is supposed to be divided into multiple files on a predetermined unit basis (e.g., for the respective options shown in FIG. 3B).

Next, in Step S9, following the user's command that has been received in the previous processing step S6, the CPU 211 determines whether or not the old recorder 30 should be initialized. If the answer is YES, the process advances to Step S10. Otherwise, the process ends.

Finally, in Step S10, the CPU 211 sends an initialize instruction (i.e., a data erase instruction) to the old recorder 30. What should be initialized is at least the data that has been inherited from the old recorder 30 to the new recorder 20 (i.e., data about the configuration setting parameters transferred and data about the recorded programs transferred). As a result, the initialization process is carried out on the old recorder 30 to end the process.

In the example described above, the recorded TV programs (i.e., recorded contents) are supposed to be transferred from the old recorder 30 to the new recorder 20. In this case, those programs do not have to be just transferred but may also be subjected to a process of changing the content encoding methods (that is a so-called “re-encoding process”). This is because the new recorder 20 may require an encoding process of higher efficiency that the old recorder's 20. That is why by adopting such a high-efficiency encoding process, the data size could be approximately halved even if the image quality was maintained.

For example, when content data compliant with the MPEG-2 standard is received from the old recorder 30, the data may be once decoded and then re-encoded in accordance with the MPEG 4 AVC (H. 264) standard. Then, the data size can be reduced significantly. If this process needs to be carried out, the new recorder 20 may have the content data, which has been acquired from the old recorder 30, decoded once by the decoder 206 and then re-encoded by the encoder 203. If the encoder 203 can also function as the decoder 206, for example, there is no need to use the decoder 206. Optionally, the data received from the old recorder 30 may also have its encoding methods changed instead of being decoded once.

Furthermore, due to a difference in function between the old and new recorders 30 and 20, the configuration setting parameters could not be used as they are. For example, as for video recording quality, even if an “ultra-long play mode” of low image quality is included in the old recorder 30, the new recorder 20 may not have such a mode. In that case, when the parameters are received, the CPU 211 may change the parameters into closer settings. Also, to realize that processing, the new recorder 20 may retain a table of correspondence between the parameters of the old recorder 30 and those of the new recorder 20. For instance, in this example, if the new recorder 20 retains a table of correspondence between the “ultra-long play mode” of the old recorder 30 and an “economy mode” of the new recorder 20, the CPU 211 may change the parameters representing the video recording quality into the “economy mode” and then store those parameters on the ROM.

Also, in the preferred embodiment described above, the recorded TV programs (i.e., recorded contents) are supposed to be transferred. However, any other type of content such as music that has been ripped from a CD and then stored on the hard disk 205b may also be transferred.

Furthermore, the “content” may include play list information that specifies only the data to read and its playback order and the image data of representative pictures to be used when the list is displayed. Optionally, the “content” may further include content library information, which includes the management information, program titles, thumbnails and other sorts of information about the content that has been recorded on a DVD.

On top of that, not just the content but also various other sorts of information about that content, including its write rate, encoding method, recording date and time, title, channel number, whether write protect is enabled or not, whether viewing control is enabled or not, and a content protection system (CPS), may be transferred. In this case, the information about the write rate may be either a bit rate value or a grade of image quality such as “high image quality”, “standard image quality” and “low image quality”.

Also, a content may sometimes include copy control information for the purpose of copyright protection. Among those various types of copy control information, if a content, of which the attributes include “COPY ONCE” (i.e., that permits the user to copy the content only once), has been transferred from the old recorder 30 to the new recorder 20, that content is automatically erased from the old recorder 30. That is to say, that content is moved.

The setting transfer function described above is introduced in order to lighten the user's workload significantly when the configuration settings are inherited from an old device to a new device. Various modified examples are imaginable for that purpose.

For instance, in the example illustrated in FIGS. 3A and 3B, the user needs to exercise the option 1 “to inherit the data stored in the old recorder” as shown in FIG. 3A and then pick the options to exercise one by one by himself or herself as shown in FIG. 3B. For a beginner who is not used to operating a machine, however, even such a selection is too much to make.

That is why a mode of operation that allows the user to avoid doing the troublesome job of choosing the data to inherit may be introduced into the new recorder 20. For example, FIG. 5 illustrates a dialog box that asks the user whether or not he or she wants to leave it to the new recorder 20 as to determining what data to inherit. As shown in FIG. 5, the dialog box includes an option 51 representing a mode in which it is the new recorder 20 that determines what data to inherit and another option 52 representing a mode in which it is the user himself or herself who has to determine what data to inherit.

If the option 51 has been exercised, data about predetermined parameters are transferred from the old recorder 30 to the new recorder 20. The “predetermined parameters” may be every parameter, for example. Optionally, not just the data about those parameters but also every recorded content may be transferred. It is also possible to determine in advance whether or not the old recorder 30 should be initialized. For example, the initialization of the old recorder 30 may be omitted.

On the other hand, if the option 52 shown in FIG. 5 is exercised, the dialog box shown in FIG. 3B is displayed.

### Embodiment 2

In the first preferred embodiment described above, the respective parameter data are transferred directly from the old recorder 30 to the new recorder 20. And to make such a transfer, both the old recorder 30 and the new recorder 20 need to be connected to the LAN 10 at the same time. That is to say, the user 30 cannot let his or her old recorder 30 go until the new recorder 20 is connected.

To overcome such a problem, according to this preferred embodiment, the respective parameter data are once transferred from the old recorder 30 to an intermediate device such as a PC. And after the new recorder 20 is connected, the parameter data that have been transferred to the PC is further transferred to the new recorder 20.

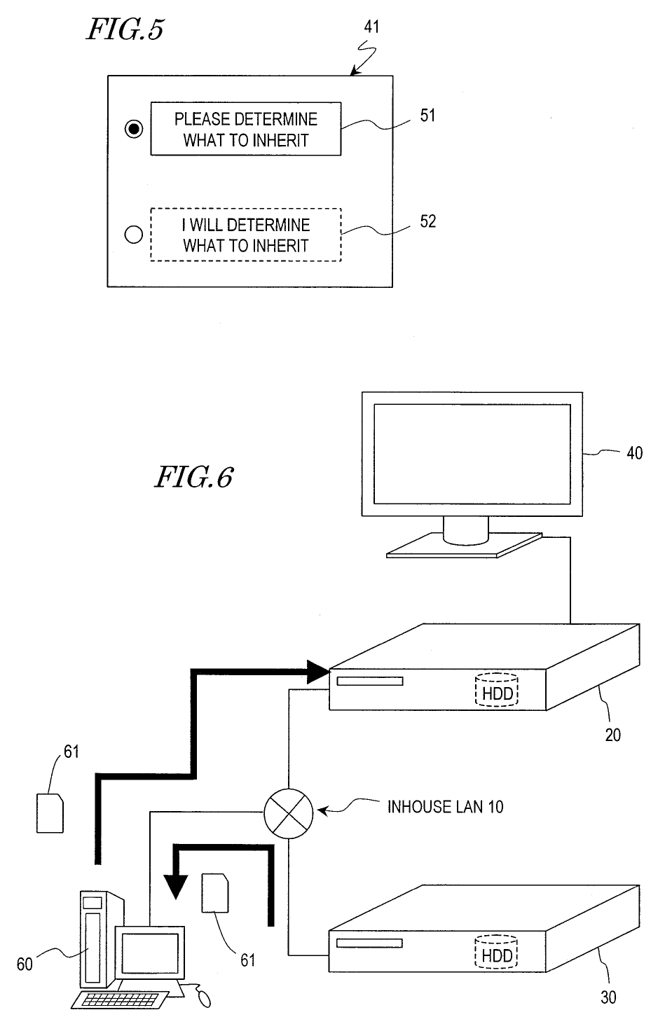

FIG. 6 illustrates a LAN 10 to which a PC 60 is connected. The PC 60 may have the same hardware configuration as the new recorder 20 shown in FIG. 2, for example. If the PC 60 does not have the recording function, then the tuner 201, the A/D converter 202, the MPEG-2 encoder 203 and the MPEG-2 decoder 206 may be omitted from the configuration shown in FIG. 2.

The operations of the PC 60 to be described below may be equivalent to what should be performed by the respective components of the new or old recorder 20 or 30 of the first preferred embodiment described above. In the following example, the PC 60 is supposed to have the configuration shown in FIG. 2 for convenience sake.

In the example illustrated in FIG. 6, the new and old recorders 20 and 30 are both connected to the LAN 10. However, this is just an example. Alternatively, the new recorder 20 may be initially disconnected from the LAN 10.

When a data transfer software program is installed in the PC 60, the PC 60 operates just like the new recorder 20 of the first preferred embodiment described above (see FIG. 4) with respect to the old recorder 30.

Using the PC 60 in place of the new recorder 20 that has already been described for the first preferred embodiment, the user chooses the parameters and contents that he or she wants to inherit from the old recorder 30. The data thus selected is divided into a number of files 61 for the respective options shown in FIG. 3B, for example, which are then transmitted from the old recorder 30 to the PC 60. On receiving those files 61 from the old recorder 30 by way of the network controller 214, the PC 60 stores them on the hard disk 20b, for example. The user can also appropriately determine whether or not to initialize the old recorder 30 and can send his or her command from the PC 60 to the old recorder 30.

Once the files 61 have been moved, the user may disconnect the old recorder 30 from the LAN 10 even before the new recorder 20 gets connected to the LAN 10. He or she may give away the old recorder 30 to somebody else or pass it to a dealer in order to throw it away.

When the new recorder 20 gets connected to the LAN 10, then the PC 60 functions as the old recorder 30 that has already been described for the first preferred embodiment with respect to the new recorder 20.

On receiving a request from the new recorder 20, the system controller 211 of the PC 60 transmits the files 61, which have been received from the old recorder 30 and saved on the hard disk 205b, to the new recorder 20 by way of the network controller 214. By receiving those files 61, the new recorder 20 can define its own configuration setting parameters based on those files 61.

If the files 61 have been generated for the respective options shown in FIG. 3B, the PC 60 may transfer all of those files 61 automatically to the new recorder 20. Alternatively, in setting up the new recorder 20, the user may choose his or her necessary files and may transfer only those files chosen to the new recorder 20.

It should be noted that the PC 60 of the preferred embodiment described above is just an example. Optionally, a third recorder, which is different from the new or old recorder 20, 30, may be used instead of the PC 60. Also, the PC 60 does not always have to be a device connected to the inhouse LAN to which the new and old recorders 20 and 30 are connected. Alternatively, the PC 60 may be a third party server PC that is connected to the LAN 10 over the Internet.

In the second preferred embodiment of the present invention described above, the parameters and contents that should be eventually transferred from the old recorder 30 to the new recorder 20 are once moved from the old recorder 30 to an intermediate device. And then the parameters and contents are transferred from that intermediate device to the new recorder 20. According to this preferred embodiment, the new and old recorders 20 and 30 do not have to be connected to the LAN 10 at the same time. Thus, the removal of the old recorder 30 and the installation of the new recorder 20 can be performed independently of each other, thus providing more handiness for the user.

### Embodiment 3

In the first preferred embodiment of the present invention described above, the single new recorder 20 is supposed to be connected to the single old recorder 30 over the LAN 10 as shown in FIG. 1.

Meanwhile, according to a third preferred embodiment of the present invention, a number of old recorders are supposed to be connected to the LAN 10. Hereinafter, it will be described how to transfer the parameters from those old recorders to the new recorder 20 in such a situation.

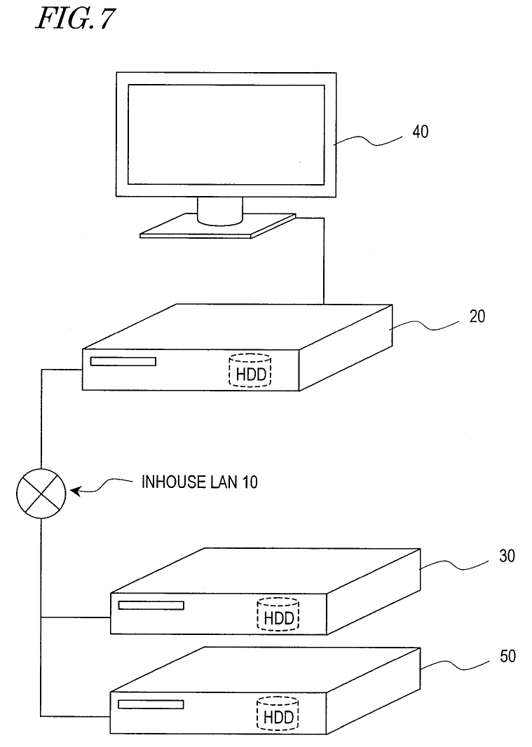

FIG. 7 illustrates a LAN 10 to which two old recorders 30 and 50 and one new recorder 20 are connected. Both of these two recorders 30 and 50 operate just as already described for the first preferred embodiment. That is why the new recorder 20 can inherit configuration setting parameters from at least one of these two old recorders 30 and 50.

In many cases, it should be enough if necessary parameters can be transferred from only one of these two old recorders 30 and 50. If the new recorder 20 has functions that are unique to these two old recorders, however, the parameters associated with those functions may be transferred from those two old recorders.

Meanwhile, as for contents, mutually different contents are stored in these two old recorders 30 and 50. It is preferably determined by the user himself or herself according to his or her preference specifically which of those contents need to be transferred to the new recorder 20.

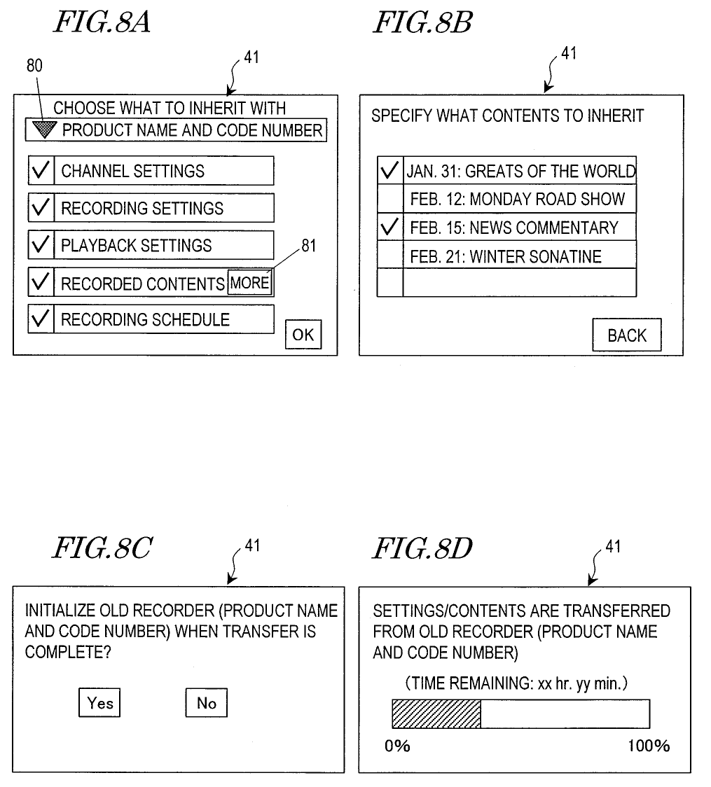

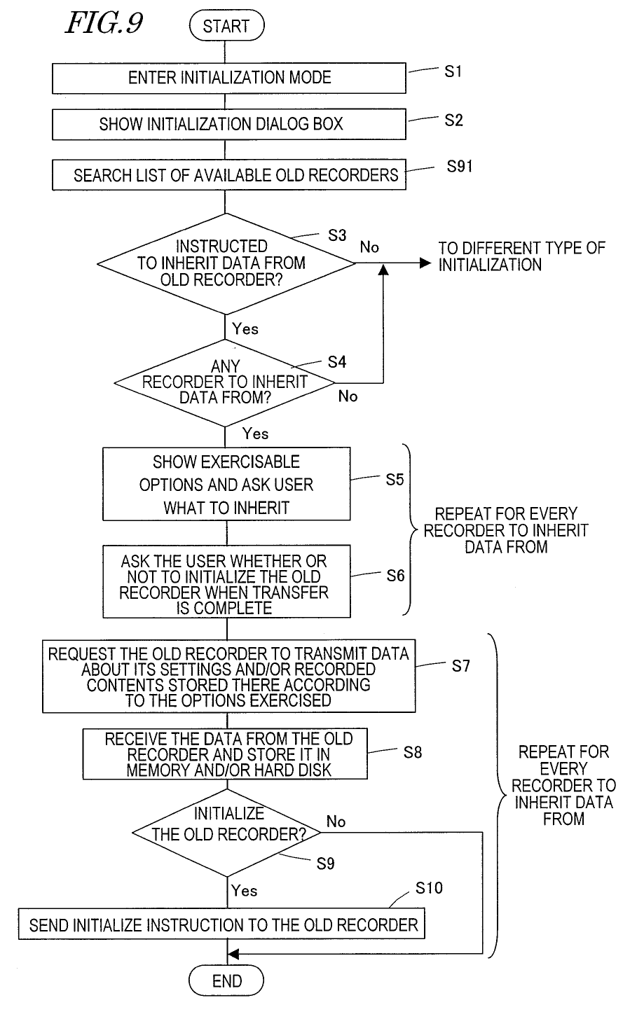

FIGS. 8A through 8D illustrate typical dialog boxes for the new recorder 20 to perform a setting transfer function on multiple old recorders.

FIG. 8A illustrates an initialization dialog box for the new recorder 20. With a pull-down menu 80, the product names and product code numbers of the old recorders 30 and 50 that are connected to the LAN 10 are selectively displayed. But before those product names and product code numbers are displayed, the new recorder 20 searches the list of available recorders that are currently connected to the LAN 10 to get the product name and product code number of a target one of the recorders. Optionally, the nicknames, numbers and address information that make the recorders identifiable on the LAN 10 may be displayed.

When the user presses the button of the pull-down menu 80 to show the details of recorded contents, the new recorder 20 displays the dialog box shown in FIG. 8B. This dialog box shows the titles and recording dates and times of the contents stored in the old recorder that has been selected with the pull-down menu 80. When the user checks the contents to inherit, the dialog boxes shown in FIGS. 8C and 8D are displayed in this order to complete the transfer process.

FIG. 9 shows the procedure in which the new recorder 20 performs the setting transfer function. This procedure is different from the one shown in FIG. 4 in that a processing step S91 is inserted between the processing steps S2 and S3. In the processing step S91, the new recorder 20 searches the list of available recorders that are currently connected to the LAN 10. As a result, the pull-down menu 80 shown in FIG. 8A can be made.

The other processing steps are the same as the counterparts shown in FIG. 4. It should be noted, however, that since there are multiple old recorders, a set of processing steps S5 and S6 and a series of processing steps S7 through S10 are carried out on each of the old recorders that have been selected with the pull-down menu 80.

According to this preferred embodiment, the configuration setting parameters and recorded contents can be transferred from multiple old recorders to the new recorder 20 either collectively or selectively according to the user's preference. Only if the user makes the selections shown in FIGS. 8A to 8C just once, everything will be transferred automatically after that, thus significantly lightening his or her workload.

In the preferred embodiments described above, the device of the present invention is supposed to be an optical disc recorder with a built-in hard disk drive (HDD). However, this is just an example. Alternatively, the device may also be a settop box with a built-in HDD for receiving a CATV or Broadcasting Satellite (BS) program for viewing. This is because unique configuration settings are also defined for such a settop box and because new settop box products have been developed one after another so frequently that the users are often inclined to purchase either a replacement or an additional device. Examples of transferable parameters about a settop box include program recording schedule information, preferred image quality settings, contents and reception channel settings.

Furthermore, the present invention is also applicable to any other type of device, not just recorders. For example, even in a read-only player, the configuration settings can also be transferred as far as the channel settings, playback settings and device settings are concerned. Also, if the present invention is applied to a settop box with no recording function, the configuration settings of the settop box can be transferred.

A content recorder/player according to the present invention requests an existent device to transmit data about the parameters that define the configuration settings of that device and data about the contents stored in that device. However, since the user can determine exactly what parameter data and content data to transfer, he or she can introduce only required data into his or her new device. Only if he or she makes that selection just once, everything will be transferred automatically after that, thus reducing the user's workload significantly. As a result, he or she can use his or her new device under the familiar configuration settings.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

This application is based on Japanese Patent Applications No. 2007-172813 filed on Jun. 29, 2007 and No. 2008-162798 filed on Jun. 23, 2008, the entire contents of which are hereby incorporated by reference.

What is claimed is:

1. A device having an ability to record and play a content and to transmit and receive data to/from at least one secondary device,
wherein at least one parameter has been set for the secondary device to define configuration settings for the secondary device, which has the function of transmitting data about the at least one parameter upon request,
the device comprising:
a network controller for transmitting and receiving data to/from the secondary device;
a system controller, which requests the secondary device to transmit the data about the at least one parameter, which has been set in the secondary device, during an initialization process; and
a storage medium for storing the data that has been transmitted from the secondary device and received at the network controller.

2. The device of claim 1, wherein the system controller further requests the secondary device to transmit at least a part of content data that is stored in the secondary device.

3. The device of claim 1, wherein on being notified that the data has been received successfully, the system controller instructs the secondary device to erase that data.

4. The device of claim 1, wherein the storage medium includes a first storage medium on which the data about the at least one parameter is written and a second storage medium on which every data about the content is written.

5. The device of claim 1, wherein the network controller has the ability to transmit and receive data to/from not only the at least one secondary device as a first terminal device but also another secondary device as a second terminal device over a network independently of each other, and
wherein in response to a request received from the second terminal device, the system controller issues an instruction that the data that has been received from the first terminal device and then stored on the storage medium be transmitted to the second terminal device, and
wherein in accordance with the instruction given by the system controller, the network controller transmits the data to the second terminal device.

6. The device of claim 5, wherein the network controller is able to communicate with the second terminal device, no matter whether the first terminal device is connected to the network or not.

7. The device of claim 1, wherein the at least one secondary device includes multiple secondary devices, and
wherein the network controller has the ability to transmit and receive data to/from each of those secondary devices, and
wherein the system controller requests at least one secondary device, which has been selected from those secondary devices, to transmit the data, and
wherein the storage medium stores the data that has been transmitted from the at least one secondary device selected and then received at the network controller.

8. A device having an ability to record and/or play a content, the device comprising:
a network controller for transmitting and receiving data to/from a secondary device, in which a number of parameters have been set to define its configuration settings;
a system controller, which requests the secondary device to transmit the data about the number of parameters, which have been set in the secondary device, during an initialization process;
a storage medium for storing the data that has been transmitted from the secondary device and received at the network controller; and
a graphics controller for generating a signal to display information on a display device,
wherein based on the signal that has been generated by the graphics controller, at least one exercisable option is displayed on the display device, and
wherein the system controller requests the secondary device to transmit data that has been defined in advance for the at least one option exercised.

9. The device of claim 8, wherein the graphics controller displays multiple exercisable options, each of which is associated with the number of parameters, and
wherein the system controller requests the secondary device to transmit the data about the parameters that are associated with the at least one option exercised.

10. The device of claim 9, wherein the system controller further requests the secondary device to transmit at least a part of content data that is stored in the secondary device.

11. The device of claim 10, wherein the parameters associated with the at least one option exercised include recording schedule information.

12. The device of claim 10, wherein the content data has been compressed by a first encoding method, and
wherein the device further includes an encoder that changes the encoding methods from the first one into a second one, which is different from the first one, on receiving the at least part of the content data and then stores the encoded data on the storage medium.

13. The device of claim 9, wherein the system controller determines whether or not the secondary device is ready to transmit the data about the parameters.

14. The device of claim 13, wherein the system controller requests the secondary device to transmit device information that identifies the secondary device itself, and
wherein based on the device information that has been transmitted from the secondary device and then received at the network controller, the system controller determines whether or not the secondary device is ready to transmit the data about the parameters.

15. The device of claim 13, wherein the graphics controller displays, as the multiple options, pieces of information about parameters that have been set in the secondary device to record the content, play the content and carry out a recording schedule, respectively.

16. The device of claim 13, further comprising a command receiver for receiving a user's command,
wherein the command receiver is instructed which of the multiple options the user is going to exercise, and
wherein the system controller requests the secondary device to transmit data required by the user's command.

17. The device of claim 13, wherein the graphics controller further displays, as another option, pieces of information indicating whether or not the data that has been transmitted from the secondary device needs to be erased from the secondary device.

18. The device of claim 17, further comprising a command receiver for receiving a user's command,
wherein when the command receiver receives a data erase command from the user, the system controller instructs the secondary device to erase the data as soon as the data has been received.

19. The device of claim 8, further comprising a command receiver for receiving a user's command,
wherein the command receiver is instructed which of the multiple options the user is going to exercise, and
wherein each of the options displayed on the display device has been associated with multiple parameters in advance, and
wherein when any of the options is exercised, the system controller requests the secondary device to transmit data about the multiple parameters that have been associated in advance with that option.
